(19) United States
(12) Patent Application Publication
(10) Pub. No.: US 2021/0042456 A1
(43) Pub. Date: Feb. 11, 2021

(54) FRP Optimization System, FRP Optimization Device, FRP Reliability Evaluation Method

(71) Applicant: Hitachi, Ltd., Chiyoda-ku, Tokyo (JP)

(72) Inventors: Sota KIMURA, Tokyo (JP); Kimiyasu YOSHIMURA, Tokyo (JP)

(21) Appl. No.: 17/041,356

(22) PCT Filed: Jan. 31, 2019
(86) PCT No.: PCT/JP2019/003356

§ 371 Date: Sep. 24, 2020

(30) Foreign Application Priority Data
May 8, 2018 (JP) 2018-090051

(51) Int. Cl. G06F 30/23; G06F 30/17; G06F 17/18

(52) U.S. Cl. CPC G06F 30/23; G06F 2119/02; G06F 17/18; G06F 30/17

(57) ABSTRACT

Provided is an FRP optimization system capable of efficiently determining the most suitable FRP specs for improving the reliability of an entire mechanical structure and its joints. In an FRP (fiber reinforced plastic) optimization system that determines specs of FRP as a structural member, the optimization system includes one or more computing devices, and the computing device includes a first calculating means configured to calculate mechanical properties according to the specs of the FRP input to the optimization system, and a second calculating means configured to determine virtual specs that give properties equivalent to the properties with a smaller number of layers than the input specs of the FRP, and analyzes a response of a mechanical structure to an external force acting on the mechanical structure including the FRP using the virtual specs obtained from the second calculating means, calculates a stress generated in the FRP using the response and the input specs of the FRP, evaluates reliability of the FRP using the stress, and determines the specs of the FRP of the mechanical structure on a basis of a result of the evaluation.

### TECHNICAL FIELD

The present invention relates to strength design of a composite material including FRP, and particularly to a technique effective to be applied to optimization and reliability evaluation of FRP as a structural member.

### BACKGROUND ART

While environmental awareness has been increasing worldwide, weight reduction of mechanical structures such as railroad cars, construction machinery, and wind turbine generators is a very important issue because it greatly contributes to a reduction in energy consumption. From such a background, in various members constituting a mechanical structure, a composite material represented by Fiber-Reinforced Plastics (hereinafter, referred to as FRP), which is superior to metal materials in specific strength and specific rigidity has been widely applied.

In order to apply FRP to structural members, it is necessary to increase the thickness of FRP itself and increase the strength and rigidity by joining with different materials. In particular, the reliability of joining with different materials is an important issue in terms of material cost suppression. In general, FRP has a multi-layer structure in which layers with different fiber directions are stacked, and specs such as the number of layers and the direction of fibers determine mechanical properties of FRP. In addition, this specs greatly affects the reliability of the entire mechanical structure using FRP and the reliability of a joint.

As one of methods for evaluating the reliability of mechanical structures, a method of analyzing a response of a structure to an external force by a structure analysis using the finite element analysis has been widely used. As a method of analyzing a response of a mechanical structure using FRP by a structural analysis using the finite element analysis, there is a method using shell elements (for example, PTL 1). Since the shell element models a multi-layer structure with a single-layer element without thickness, it has advantages such as a reduction in calculation load and a reduction in time required to create a calculation model. On the other hand, it is a method that does not take into account the thickness, the accuracy of evaluation of stress that occurs in a thick FRP may decrease, or a spatial gap may occur in a joint, resulting in a reduction in accuracy of a reliability evaluation of the joint.

In a structural analysis using the finite element analysis, there is also a method of using solid elements that takes into account the thickness. When the solid element is used, a spatial gap does not occur in the joint, and the accuracy of a reliability evaluation of the joint can be maintained. However, when modeling a multi-layer structure with the solid elements, there are problems that it takes a lot of time to reflect corrections/changes of the stacking configuration in a calculation model, and modeling the stacking configuration in detail increases the calculation load. Therefore, it is difficult to efficiently evaluate the reliability of FRP with these methods.

### CITATION LIST

### Patent Literature

PTL 1: JP 2004-110793 A

### SUMMARY OF INVENTION

### Technical Problem

As described above, in the reliability evaluation of mechanical structures using FRP, the analysis using the shell elements has the advantages of reducing the calculation load and the time required to create the calculation model, but there is a problem that the accuracy of reliability evaluation of the joint is reduced.

Further, although the analysis using the solid elements can maintain the accuracy in the reliability evaluation of the joint, it has a problem that the calculation load increases and the time required to create the calculation model increases.

Therefore, an object of the present invention is to provide an FRP optimization system and an FRP optimization device capable of efficiently determining the most suitable FRP specs for improving the reliability of the entire mechanical structure using FRP as a structural member and its joints.

Further, another object of the present invention is to provide an FRP reliability evaluation method that is capable of accurately evaluating the reliability of FRP that is a structural member.

### Solution to Problem

In order to solve the above problem, the present invention is an FRP (fiber reinforced plastic) optimization system that determines specs of FRP as a structural member, in which the optimization system includes one or more computing devices, and the computing device includes a first calculating means configured to calculate mechanical properties according to the specs of the FRP input to the optimization system, and a second calculating means configured to determine virtual specs that give properties equivalent to the properties with a smaller number of layers than the input specs of the FRP, and analyzes a response of a mechanical structure to an external force acting on the mechanical structure including the FRP using the virtual specs obtained from the second calculating means, calculates a stress generated in the FRP using the response and the input specs of the FRP, evaluates reliability of the FRP using the stress, and determines the specs of the FRP of the mechanical structure on a basis of a result of the evaluation.

Further, the present invention is an FRP (fiber reinforced plastic) optimization device that determines specs of the FRP as a structural member, the FRP optimization device including: an input unit configured to input the specs of the FRP; and a computation processing unit configured to determine the specs of the FRP of a target mechanical structure, in which the computation processing unit includes: a first calculating means configured to calculate mechanical properties of the FRP on a basis of the specs of the FRP input from the input unit; a second calculating means configured to calculate virtual stacking specs on a basis of the mechanical properties calculated by the first calculating means; a response analysis means configured to analyze a response of a mechanical structure to an external force acting on the mechanical structure including FRP on a basis of the virtual stacking specs calculated by the second calculating means; a stress calculating means configured to calculate a stress generated in the FRP on a basis of the response of the mechanical structure analyzed by the response analysis means and the specs of the FRP input from the input unit; a reliability parameter calculating means configured to calculate a reliability parameter correlated with reliability of the FRP on a basis of the stress calculated by the stress calculating means; and an optimum value calculating means configured to calculate an optimum value of the specs of the FRP of the mechanical structure on a basis of a value of the reliability parameter calculated by the reliability parameter calculating means.

Further, the present invention is an FRP (fiber reinforced plastic) reliability evaluation method for evaluating reliability of the FRP as a structural member, the FRP reliability evaluation method including: (a) a step of inputting specs of the FRP; (b) a step of calculating mechanical properties of the FRP on a basis of the specs of the FRP input in the step (a); (c) a step of calculating virtual stacking specs that give equivalent mechanical properties with a smaller number of layers than the specs of the FRP input in the step (a); (d) a step of analyzing a response of a mechanical structure to an external force acting on the mechanical structure including FRP on a basis of the virtual stacking specs calculated in the step (c); (e) a step of calculating a stress generated in the FRP on a basis of the response of the mechanical structure analyzed in the step (d) and the specs of the FRP input in the step (a); and (f) a step of calculating a reliability parameter correlated with reliability of the FRP on a basis of the stress calculated in the step (e).

### Advantageous Effects of Invention

According to the present invention, it is possible to achieve an FRP optimization system and an FRP optimization device capable of efficiently determining the most suitable FRP specs for improving the reliability of the entire mechanical structure using FRP as a structural member and its joints.

Further, it is possible to achieve an FRP reliability evaluation method capable of accurately evaluating the reliability of FRP that is a structural member.

This makes it possible to efficiently determine the FRP specs most suitable for improving the reliability of the mechanical structure including the FRP, and improve the reliability of a mechanical structure portion.

The problems, configurations, and effects other than those described above will be more clarified in a description of embodiments described below.

### BRIEF DESCRIPTION OF DRAWINGS

FIG. 1 is a flowchart showing a processing flow of an optimization system according to an embodiment of the present invention. (Example 1).

FIG. 2 is a diagram showing an example of a stacking model.

FIG. 3 is a diagram showing a device including the optimization system according to the embodiment of the present invention.

FIG. 4 is a diagram showing a display example of optimum values in the optimization system according to the embodiment of the present invention.

FIG. 5 is a flowchart showing a processing flow of an optimization system according to the embodiment of the present invention. (Example 2).

FIG. 6 is a flowchart showing a processing flow of an optimization system according to the embodiment of the present invention. (Example 3).

FIG. 7 is a flowchart showing a processing flow of an optimization system according to the embodiment of the present invention. (Example 4).

### DESCRIPTION OF EMBODIMENTS

An example of the present invention is described below in conjunction with the drawings. Note that, in each drawing, the same configurations are designated by the same reference numerals, and detailed description of the same portions will be omitted.

### EXAMPLE 1

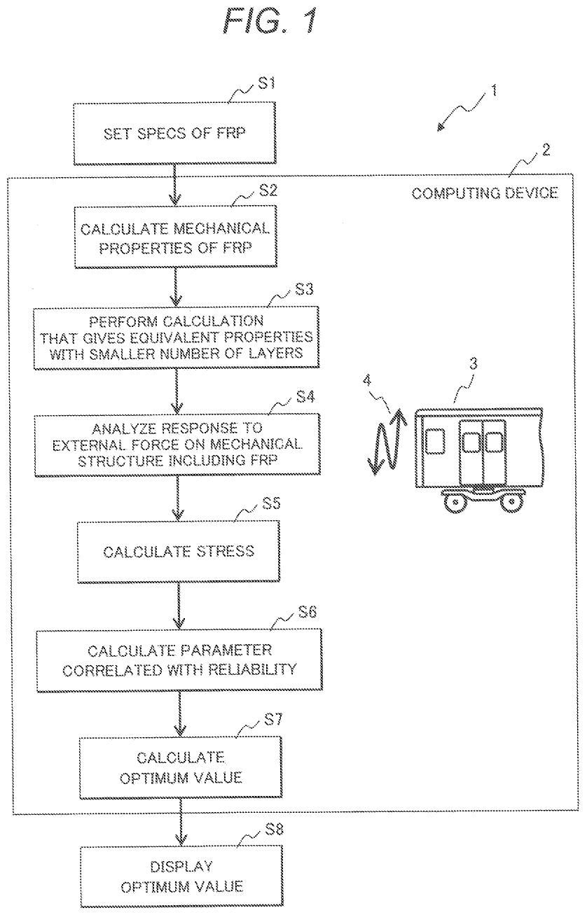

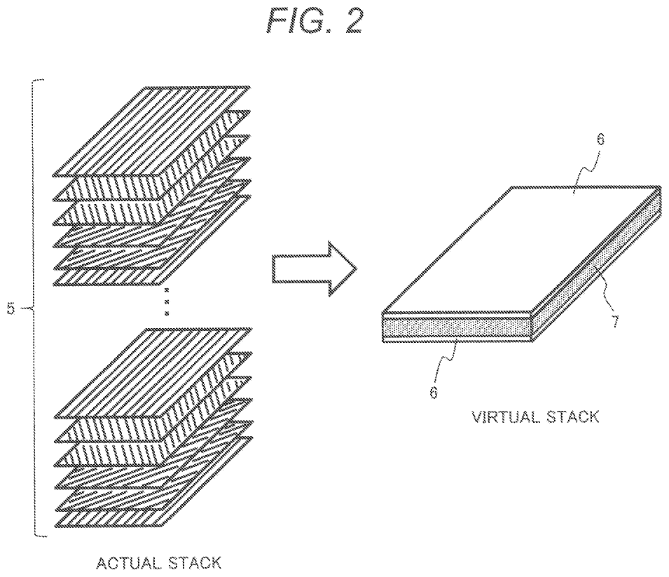

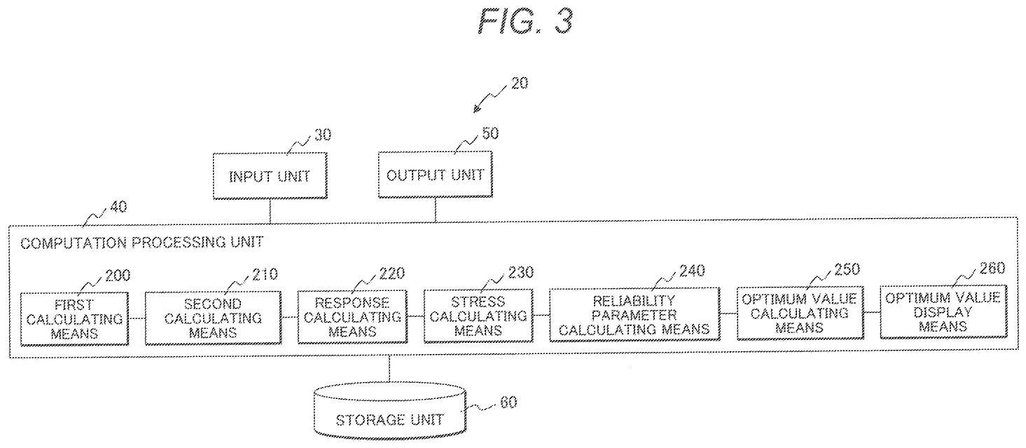

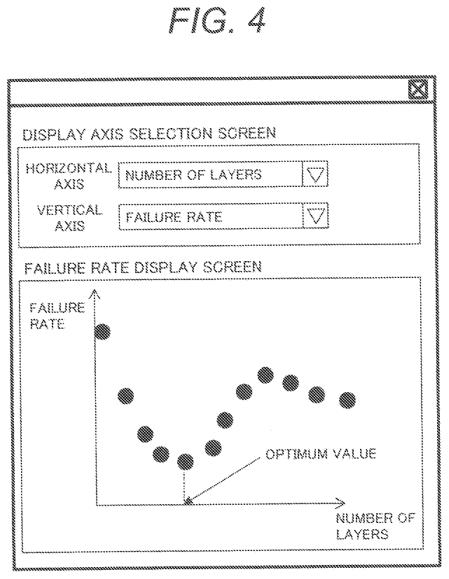

With reference to FIGS. 1 to 4, description will be given of an FRP optimization system of Example 1, a device including the same, and an FRP reliability evaluation method. FIG. 1 is a flowchart showing a processing flow of an optimization system of the present example. FIG. 2 is an example of a stacking model, and conceptually shows an example of actual stacking and virtual stacking with a smaller number of layers. FIG. 3 is a schematic configuration diagram showing a device including the optimization system of the present example. FIG. 4 is a display example of an optimum value.

As shown in FIG. 1, an FRP optimization system 1 of the present example includes a computing device 2 as a main configuration. In this system, specs of FRP are first set (input to the computing device 2) using an input device (not shown). (Step S1)

Next, mechanical properties of the FRP are calculated according to the specs of the FRP set in step S1. (Step S2)

Subsequently, virtual stacking specs that give equivalent mechanical properties with a smaller number of layers than the FRP specs set in step S1 is determined (calculated). (Step S3)

Subsequently, a response of a mechanical structure 3 to an external force 4 acting on the mechanical structure 3 including the FRP is analyzed using the virtual stacking specs determined (calculated) in step S3. (Step S4) FIG. 1 shows a railroad car as an example of the mechanical structure 3.

Subsequently, a stress generated in the FRP is calculated using the response of the mechanical structure 3 analyzed in step S4 and the FRP specs set in step S1. (Step S5)

Subsequently, the stress calculated in step S5 is used to evaluate (calculate) parameters having a correlation with the reliability of FRP (hereinafter referred to as reliability parameters). (Step S6)

Subsequently, an optimum value of the FRP specs most suitable for improving the reliability of the mechanical structure 3 is searched (calculated) using the value of the reliability parameters evaluated (calculated) in step S6. (Step S7)

Finally, the optimum value of the FRP specs searched (calculated) in step S7 is displayed on an external display device (not shown). (Step S8)

As shown in FIG. 2, the virtual stacking specs described above can be obtained by solving Equation 3 from Equation 1 representing in-plane rigidity A and bending rigidity D of the entire FRP of an actual stack 5 using mechanical property Q and thickness t of each layer (X layer 6 and Y layer 7) in a virtual stack in which the number of layers is smaller than that of the actual stack 5. Note that it is assumed that the total value of the thickness t matches the thickness t of the actual stack 5.

$$\begin{matrix}[ Formula 1 ] & \\ {\underline{Q}}_{ij , 1} \cdot {\underline{t}}_{1} + {\underline{Q}}_{ij , 2} \cdot {\underline{t}}_{2} = \frac{{A}_{ij}}{2} & ( Equation 1 )\end{matrix}$$

Q: Rigidity of each layer of virtual stack

t: Thickness of each layer of virtual stack

A: In-plane rigidity of actual stack

D: Bending rigidity of actual stack

t: Thickness of actual stack

$$\begin{matrix}[ Formula 2 ] & \\ \frac{1}{3} [ {\underline{Q}}_{ij , 2} \cdot {\underline{t}}_{2}^{3} + {\underline{Q}}_{ij , 1} \cdot \{ {( {\underline{t}}_{1} + {\underline{t}}_{2} )}^{3} - {\underline{t}}_{2}^{3} \} ] = \frac{{D}_{ij}}{2} \\ ( i , j = 1 , 2 , 6 ) & ( Equation 2 ) \\ [ Formula 3 ] & \\ {\underline{t}}_{1} + {\underline{t}}_{2} = t & ( Equation 3 )\end{matrix}$$

Further, as shown in Equation 4, a stress σ generated in the FRP calculated in step S5 of FIG. 1 is obtained from the strain obtained as a result of analysis of the response analyzed in step S4 and the rigidity of each layer in the actual stack 5.

[Formula 4]

{σᵢⱼ}=└Qᵢⱼ┘{εᵢⱼ} (i, j=1, 2, 6) (Equation 4)
Q: Rigidity of each layer of actual stack
ε: Strain obtained by structure analysis
σ: Stress

A device 20 including the optimization system 1 of the present example, as shown in FIG. 3, includes an input unit 30, a computation processing unit 40, an output unit 50, and a storage unit 60 as main configurations. The computation processing unit 40 includes a first calculating means 200, a second calculating means 210, a calculating means 220 for the response in step S4 of FIG. 1, a calculating means 230 for the stress in step S5 of FIG. 1, a calculating means 240 for the reliability parameter in step S6 of FIG. 1, and a calculating means 250 for the optimum value and a display means 260 for the optimum value in step S7 of FIG. 1. The optimum value is displayed on a graph showing the relationship between the number of layers and the failure rate, as shown, for example, in FIG. 4.

The first calculating means 200 calculates the mechanical properties of the FRP in step S2 of FIG. 1, and the second calculating means 210 calculates the virtual stacking specs in step S3 of FIG. 1.

As described above, with the FRP optimization system of the present example and the device including the same, it is possible to efficiently search (calculate) an optimum value of the FRP specs most suitable for improving the reliability of the mechanical structure 3 such as a railroad car without sequentially modeling FRP stacking configurations having different specs.

Further, unlike the case of modeling the FRP without taking into account the thickness, the joint can be modeled without a spatial gap, and a reduction in accuracy of reliability evaluation of the joint can be avoided.

Note that the evaluation of the reliability of the entire mechanical structure using FRP as a structural member and its joints can be performed by executing the processing from step S1 to step S6 shown in FIG. 1 and evaluating (calculating) the parameters (reliability parameters) correlating with the reliability of FRP.

### EXAMPLE 2

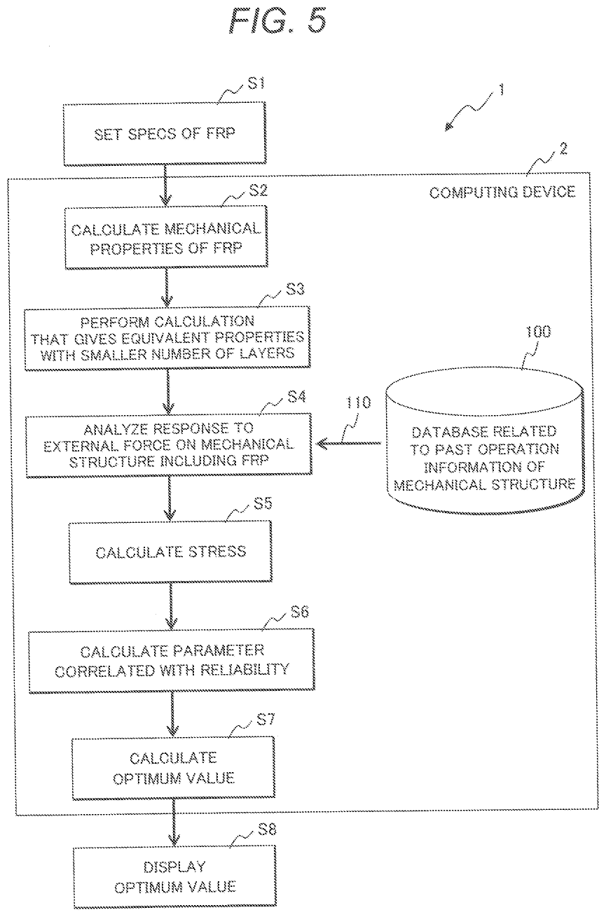

An FRP optimization system according to Example 2 will be described with reference to FIG. 5.

The optimization system 1 of the present example is different from the optimization system of Example 1 in that the computing device 2 further includes a database 100 in which past operation information of the mechanical structure 3 is accumulated (stored).

As shown in FIG. 5, the optimization system 1 of the present example includes the database 100 in the computing device 2, and the database 100 accumulates (stores) past operation information of the mechanical structure 3. The computing device 2 extracts a parameter 110 having a correlation with the response of the mechanical structure 3 from the database 100, and analyzes the response of the mechanical structure 3 using the parameter 110. (Step S4)

The stress generated in the FRP is calculated using the response of the mechanical structure 3 analyzed in step S4 and the FRP specs set in step S1. (Step S5)

Then, similarly to the processing flow of FIG. 1 of Example 1, the reliability parameter is evaluated using the calculated stress (step S6), and the optimum value of the FRP specs the most suitable for improving the reliability of the mechanical structure 3 is searched (calculated) using the value of the reliability parameter. (Step S6)

This makes it possible to determine the optimum FRP specs for improving the reliability of the mechanical structure 3 while dealing with a more complicated response during operation than in the optimization system of Example 1.

### EXAMPLE 3

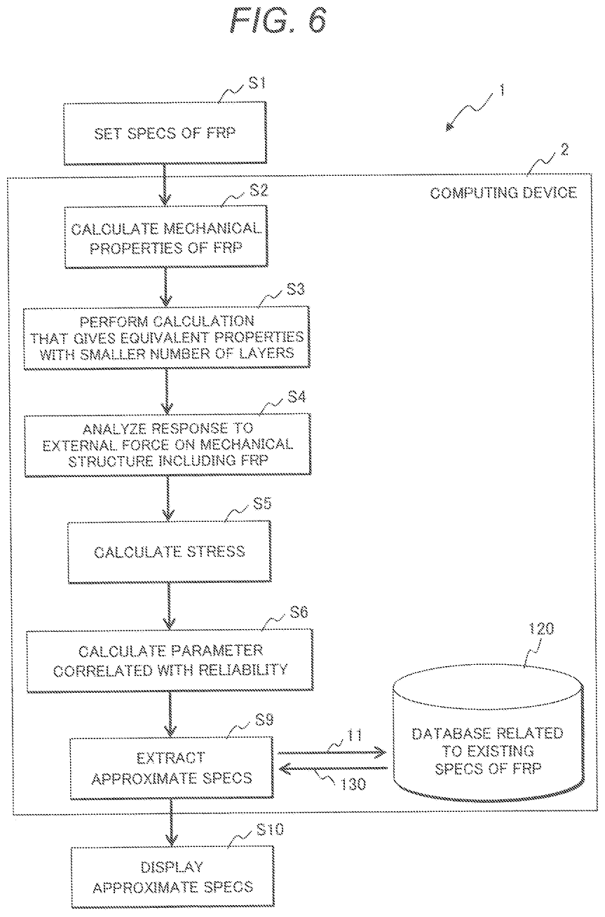

An FRP optimization system according to Example 3 will be described with reference to FIG. 6.

The optimization system 1 of the present example differs from the optimization system of Example 1 in that the computing device 2 further includes a database 120 in which existing specs of FRP are accumulated (stored).

In the optimization system 1 of the present example, as shown in FIG. 6, the computing device 2 includes the second database 120 different from the database 100 (first database) of Example 2 (FIG. 5), and the second database 120 accumulates (stores) existing FRP specs 130. The computing device 2 extracts approximate specs 140 closest to the optimum value from the second database 120 (step S9), and displays the approximate specs of the FRP extracted in step S9 on an external display device (not shown). (Step S10)

This makes it possible to select manufacturable FRP specs and to design a structure using existing specs.

### EXAMPLE 4

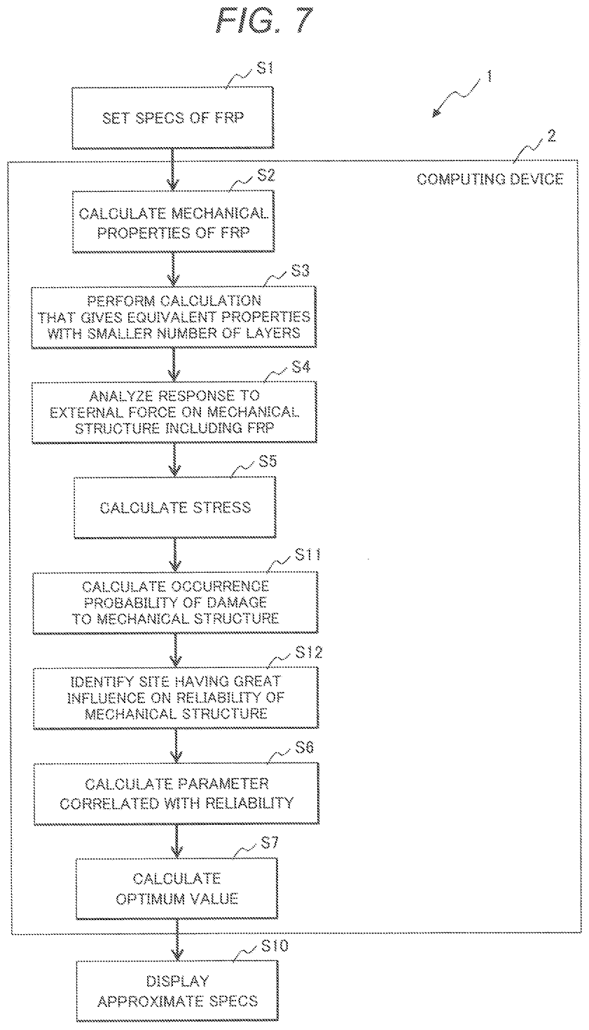

An FRP optimization system according to Example 4 will be described with reference to FIG. 7.

The optimization system 1 according to the present example is different from the optimization system according to Example 1 in that steps S11 and S12 are further executed in the computing device 2 between step S5 and step S6 of Example 1 (FIG. 1). Further, the point that the approximate specs are displayed at the end is also different from Example 1. (Step S10)

With the optimization system 1 of the present example, as shown in FIG. 7, the computing device 2 predicts (calculates) occurrence probability 150 of damage in the mechanical structure 3 (step S11) and, based on the prediction result, identifies a site 160 where damage, which has a great influence on the reliability of the mechanical structure 3, occurs. (Step S12) In the present example, the FRP specs most suitable for reducing the occurrence probability 150 of damage in the site 160 are determined.

This makes it possible to predict the reliability of the mechanical structure 3 with higher accuracy and determine the optimum FRP specs according to the prediction result. Furthermore, it becomes possible to more efficiently determine the optimum value of the FRP specs.

The optimization system in each of the examples described above can also analyze the response of the mechanical structure 3 according to the operation data of the mechanical structure 3 and, based on the analysis result, determine the FRP specs most suitable for improving the reliability of the mechanical structure 3 in operation. This makes it possible to determine, for example, the repair method for the FRP included in the mechanical structure 3 in operation.

Note that, in each of the examples, a railroad car is assumed as a specific example of the mechanical structure 3, but similar effects can be obtained in the field of products requiring a mechanical strength and using thick composite materials such as a construction machine or a wind turbine generator other than the railroad car.

Further, the present invention is not limited to the above-mentioned examples, but includes various modifications. For example, the above-described examples have been described in detail in order to describe the present invention in an easy-to-understand manner, and are not necessarily limited to those having all the configurations described. Further, a part of the configuration of a certain example can be replaced with the configuration of another example, and the configuration of another example can be added to the configuration of a certain example. Further, it is possible to add/delete/replace another configuration with respect to a part of the configurations of the examples.

### REFERENCE SIGNS LIST

1 optimization system
2 computing device
3 mechanical structure (railroad car)
4 external force
5 actual stack
6 X layer
7 Y layer
20 device
30 input unit
40 computation processing unit
50 output unit
60 storage unit
100 (first) database
110 parameter correlated with response
120 (second) database
130 existing FRP specs
140 approximate FRP specs
150 occurrence probability of damage in mechanical structure 3
160 site where damage having great influence on reliability of mechanical structure 3 occurs
200 first calculating means
210 second calculating means
220 response calculating means
230 stress calculating means
240 reliability parameter calculating means
250 optimum value calculating means
260 optimum value display means

1. An FRP (fiber reinforced plastic) optimization system that determines specs of FRP as a structural member, wherein
the optimization system comprises one or more computing devices, and
the computing device includes
a first calculating means configured to calculate mechanical properties according to the specs of the FRP input to the optimization system, and
a second calculating means configured to determine virtual specs that give properties equivalent to the properties with a smaller number of layers than the input specs of the FRP, and
analyzes a response of a mechanical structure to an external force acting on the mechanical structure including the FRP using the virtual specs obtained from the second calculating means, calculates a stress generated in the FRP using the response and the input specs of the FRP, evaluates reliability of the FRP using the stress, and determines the specs of the FRP of the mechanical structure on a basis of a result of the evaluation.

2. The FRP optimization system according to claim 1, wherein the computing device includes a first database storing operation information of the mechanical structure including the FRP, extracts the operation information from the first database, analyzes the response of the mechanical structure using the operation information, calculates the stress generated in the FRP using the response and the input specs of the FRP, evaluates the reliability of the FRP using the stress, and determines the specs of the FRP of the mechanical structure on a basis of a result of the evaluation.

3. The FRP optimization system according to claim 1, wherein the computing device includes a second database storing existing specs of the FRP, and determines specs of FRP of the mechanical structure on a basis of the result of the evaluation and the existing specs extracted from the second database.

4. The FRP optimization system according to claim 1, wherein the computing device includes a damage position prediction means configured to predict a position where damage occurs in the mechanical structure including the FRP, and determines the specs of the FRP of the mechanical structure on a basis of a prediction result of the damage position prediction means.

5. An FRP (fiber reinforced plastic) optimization device that determines specs of the FRP as a structural member, the FRP optimization device comprising:
an input unit configured to input the specs of the FRP; and
a computation processing unit configured to determine the specs of the FRP of a target mechanical structure, wherein
the computation processing unit includes:
a first calculating means configured to calculate mechanical properties of the FRP on a basis of the specs of the FRP input from the input unit;
a second calculating means configured to calculate virtual stacking specs on a basis of the mechanical properties calculated by the first calculating means;
a response analysis means configured to analyze a response of a mechanical structure to an external force acting on the mechanical structure including FRP on a basis of the virtual stacking specs calculated by the second calculating means;
a stress calculating means configured to calculate a stress generated in the FRP on a basis of the response of the mechanical structure analyzed by the response analysis means and the specs of the FRP input from the input unit;
a reliability parameter calculating means configured to calculate a reliability parameter correlated with reliability of the FRP on a basis of the stress calculated by the stress calculating means; and
an optimum value calculating means configured to calculate an optimum value of the specs of the FRP of the mechanical structure on a basis of a value of the reliability parameter calculated by the reliability parameter calculating means.

6. The FRP optimization device according to claim 5, further comprising
a first database storing operation information of the mechanical structure including the FRP.

7. The FRP optimization device according to claim 5, further comprising
a second database storing existing specs of the FRP.

8. The FRP optimization device according to claim 5, further comprising
a damage position prediction means that predicts a position where damage occurs in the mechanical structure including the FRP.

9. An FRP (fiber reinforced plastic) reliability evaluation method for evaluating reliability of the FRP as a structural member, the FRP reliability evaluation method comprising:
(a) a step of inputting specs of the FRP;
(b) a step of calculating mechanical properties of the FRP on a basis of the specs of the FRP input in the step (a);
(c) a step of calculating virtual stacking specs that give equivalent mechanical properties with a smaller number of layers than the specs of the FRP input in the step (a);
(d) a step of analyzing a response of a mechanical structure to an external force acting on the mechanical structure including FRP on a basis of the virtual stacking specs calculated in the step (c);
(e) a step of calculating a stress generated in the FRP on a basis of the response of the mechanical structure analyzed in the step (d) and the specs of the FRP input in the step (a); and
(f) a step of calculating a reliability parameter correlated with reliability of the FRP on a basis of the stress calculated in the step (e).

10. The FRP reliability evaluation method according to claim 9, comprising
between the step (c) and the step (d),
(g) a step of extracting operation information of the mechanical structure including the FRP, wherein
the response of the mechanical structure is analyzed on a basis of the operation information.

11. The FRP reliability evaluation method according to claim 9, comprising:
between the step (e) and the step (f),
(h) a step of calculating an occurrence probability of damage in the mechanical structure; and
(i) a step of identifying a damage occurrence site in the mechanical structure on a basis of the occurrence probability of damage calculated in the step (h).
